(19) United States
(12) Patent Application Publication
(10) Pub. No.: US 2015/0029308 A1
(43) Pub. Date: Jan. 29, 2015

(54) APPARATUS AND METHOD FOR RECONSTRUCTING SCENE OF TRAFFIC ACCIDENT

(71) Applicant: ELECTRONICS AND TELECOMMUNICATIONS RESEARCH INSTITUTE, Daejeon-city (KR)

(72) Inventors: Seungjun HAN, Daejeon (KR); Juwan KIM, Daejeon (KR); Kyoungwook MIN, Sejong (KR); Jeongdan CHOI, Daejeon (KR)

(73) Assignee: ELECTRONICS AND TELECOMMUNICATIONS RESEARCH INSTITUTE, Daejeon-city (KR)

(21) Appl. No.: 14/320,421

(22) Filed: Jun. 30, 2014

(30) Foreign Application Priority Data
Jul. 29, 2013 (KR) 10-2013-0089705

(51) Int. Cl. H04N 13/00

(52) U.S. Cl. CPC H04N 13/004; H04N 13/0055
USPC 348/43

(57) ABSTRACT

Disclosed are an apparatus and method for reconstructing the scene of a traffic accident. The apparatus includes an information collection unit for receiving images and sounds of a scene of a traffic accident and a stationary object and a moving object located around the scene. A stationary object reconstruction unit reconstructs a 3D shape of the stationary object, and constructs a 3D accident environment. A moving object reconstruction unit aligns the images in time, detecting motions of the moving object from the aligned images, and combines the detected motions of the moving object into the 3D accident environment including the reconstructed stationary object according to times. A reproduction unit reproduces the scene of the traffic accident at corresponding time based on results of combination in response to a time-based playback request, the scene of the traffic accident being reproduced so that the 3D moving object is moved.

### CROSS REFERENCE TO RELATED APPLICATION

This application claims the benefit of Korean Patent Application No. 10-2013-0089705, filed on Jul. 29, 2013, which is hereby incorporated by reference in its entirety into this application.

### BACKGROUND OF THE INVENTION

1. Technical Field

The present invention relates generally to an apparatus and method for reconstructing the scene of a traffic accident and, more particularly, to an apparatus and method for reconstructing the scene of a traffic accident, which reconstruct the scene of a traffic accident in three-dimensions (3D) using various types of image information captured when the traffic accident occurs.

2. Description of the Related Art

A conventional black box is fixed and mounted in a vehicle. Such a conventional black box is disadvantageous in that images (videos) stored therein are played to reconstruct the scene of a traffic accident only from a fixed viewpoint, and is problematic in that a portion of a shadow area hidden by an obstacle ahead of a vehicle cannot be viewed.

The determination of accidents using images stored in a conventional black box is subjectively performed using only images captured by and stored in the black box. However, since the images of the black box are captured using a wide-angle lens, these images are seriously distorted. Accordingly, since determination is subjectively performed using distorted images, the results of such determination may occasionally be erroneous. Therefore, there is a need to accurately reconstruct and determine the situation of an accident via 3D reconstruction of black box images.

In order to more accurately analyze a traffic accident, a shadow area must not be present in the scene of a traffic accident, the scene of the traffic accident must be reconstructed from various viewpoints with time, and a length or area measurement function, such as for the measurement of a distance between vehicles in the reconstructed scene of the traffic accident, must be provided.

Further, existing technology for reconstructing the scene of a traffic accident is configured such that the scene of a traffic accident can be reconstructed in 3D using an image sensor, such as a camera, and a laser scanner. By means of such conventional technology for reconstructing the scene of a traffic accident, the scene of the traffic accident may be viewed from various viewpoints, but it is impossible to reconstruct images ranging from images recorded before the traffic accident occurs to images corresponding to the movement of a vehicle, the motion of a person, or the like, with the lapse of time in 3D.

In the past, simulation is occasionally performed based on 3D graphics using the movement information or the like of a vehicle stored in a black box. However, in this case, there is a definite difference between an actual situation of a traffic accident and the simulation of the accident reconstructed using 3D graphics, and it is difficult to consider that such a simulation completely reflects the situation of the actual traffic accident without change.

In other words, since a method of viewing black box images is configured to check only the black box images, it is impossible to check portions that cannot be recorded by the black box. When there are images that are separately captured, a method of inferring the situation of a traffic accident while additionally viewing the scene of the traffic accident has been used. Therefore, there is a disadvantage in that it is difficult to accurately reconstruct the scene of a traffic accident. Meanwhile, a method of reconstructing the scene of an accident using a laser scanner and an image sensor in 3D is advantageous in that the scene of the accident can be accurately reenacted, but a situation before the occurrence of the traffic accident cannot be reconstructed, thus causing limitations in detecting the actual cause of the traffic accident.

As a related preceding technology, Korean Patent No. 1040118 (entitled “System and method for reconstructing a traffic accident”) discloses a technology that automatically reconstructs the situation of a traffic accident based on the black box information of a vehicle, Geographic Information System (GIS) information, sensor information, and weather information, which are automatically received when the accident occurs, without requiring field investigation.

The invention disclosed in Korean Patent No. 1040118 is merely configured to construct a virtual accident environment based on the black box information of a vehicle, GIS information, sensor information, and weather information, and graphically represent correlations between objects with respect to the situation of the traffic accident.

### SUMMARY OF THE INVENTION

Accordingly, the present invention has been made keeping in mind the above problems occurring in the prior art, and an object of the present invention is to provide an apparatus and method for reconstructing the scene of a traffic accident, which reconstruct the scene of a traffic accident into an actual image-based 3D traffic accident procedure based on images captured in various environments such as Closed Circuit Televisions (CCTVs) installed on a roadside, as well as black box images captured from various viewpoints in a plurality of vehicles, thus enabling scenes before and after the occurrence of the traffic accident including the time of the occurrence of the traffic accident to be reconstructed at various angles.

In accordance with an aspect of the present invention to accomplish the above object, there is provided an apparatus for reconstructing a scene of a traffic accident, including an information collection unit for receiving images and sounds of a scene of a traffic accident and a stationary object and a moving object located around the scene; a stationary object reconstruction unit for reconstructing a three-dimensional (3D) shape of the stationary object based on the received images, and constructing a 3D accident environment; a moving object reconstruction unit for aligning the received images in time, detecting motions of the moving object from the aligned images, and combining the detected motions of the moving object into the 3D accident environment including the reconstructed stationary object according to individual times; and a reproduction unit for reproducing the scene of the traffic accident at a corresponding time based on results of combination by the moving object reconstruction unit in response to a time-based playback request, the scene of the traffic accident being reproduced so that the 3D moving object is moved.

Preferably, the information collection unit may receive images and sounds from a black box installed in a vehicle, a Closed Circuit Television (CCTV) installed on a roadside, and a mobile phone.

Preferably, the stationary object reconstruction unit may include a feature extraction unit for extracting features from the images collected by the information collection unit; a corresponding point search unit for searching for corresponding points of the extracted features; an optimization unit for obtaining 3D location coordinates of found corresponding points; and a calibration unit for calibrating a scale of the 3D location coordinates based on actually measured data or estimated data.

Preferably, the moving object reconstruction unit may include a time alignment unit for aligning the received images in time for respective sequences; a moving object motion reconstruction unit for obtaining locations of motions of the moving object present in the respective image sequences that are temporally synchronized; and a combination unit for combining the motions of the moving object into the 3D accident environment so that the motions are temporally synchronized with each other.

Preferably, the time alignment unit may align the received images by using a time, at which a difference in variations between the received images is minimized, as an identical time at which the images are temporally synchronized with each other.

Preferably, the time alignment unit may align the received images based on a common sound when sounds are included in the received images.

Preferably, the time alignment unit may receive a signal obtained by adjusting time code of the received images, and align the received images based on the signal.

Preferably, the reproduction unit may reproduce the scene of the traffic accident by performing a 3D rendering task.

Preferably, the apparatus may further include a database for storing results of combination by the moving object reconstruction unit.

In accordance with another aspect of the present invention to accomplish the above object, there is provided a method for reconstructing a scene of a traffic accident, including receiving, by an information collection unit, images and sounds of a scene of a traffic accident and a stationary object and a moving object located around the scene; reconstructing, by a stationary object reconstruction unit, a three-dimensional (3D) shape of the stationary object based on the received images, and constructing a 3D accident environment; aligning, by a moving object reconstruction unit, the received images in time, detecting motions of the moving object from the aligned images, and combining the detected motions of the moving object into the 3D accident environment including the reconstructed stationary object according to individual times; and reproducing, by a reproduction unit, the scene of the traffic accident at a corresponding time based on results of the combination in response to a time-based playback request, the scene of the traffic accident being reproduced so that the 3D moving object is moved.

Preferably, receiving may be configured to receive images and sounds from a black box installed in a vehicle, a Closed Circuit Television (CCTV) installed on a roadside, and a mobile phone.

Preferably, constructing the 3D accident environment may include extracting features from the images received at receiving; searching for corresponding points of the extracted features; obtaining 3D location coordinates of found corresponding points; and calibrating a scale of the 3D location coordinates based on actually measured data or estimated data.

Preferably, combining may include aligning the received images in time for respective sequences; obtaining locations of motions of the moving object present in the respective image sequences that are temporally synchronized; and combining the motions of the moving object into the 3D accident environment so that the motions are temporally synchronized with each other.

Preferably, aligning may be configured to align the received images by using a time, at which a difference in variations between the received images is minimized, as an identical time at which the images are temporally synchronized with each other.

Preferably, aligning may be configured to align the received images based on a common sound when sounds are included in the received images.

Preferably, aligning may be configured to receive a signal obtained by adjusting time code of the received images, and align the received images based on the signal.

Preferably, reproducing may be configured to reproduce the scene of the traffic accident by performing a 3D rendering task.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an example of the scene of a traffic accident employed in the description of the embodiment of the present invention;

FIG. 2 is a diagram showing the configuration of an apparatus for reconstructing the scene of a traffic accident according to an embodiment of the present invention;

FIG. 3 is a diagram showing the internal configuration of a stationary object reconstruction unit shown in FIG. 2;

FIG. 4 is a diagram showing a relationship between corresponding points and cameras in an embodiment of the present invention;

FIG. 5 is a diagram showing the internal configuration of a moving object reconstruction unit shown in FIG. 2;

FIG. 6 is a diagram showing time synchronization and alignment between image sequences in an embodiment of the present invention;

FIG. 7 is a flowchart schematically showing a method for reconstructing the scene of a traffic accident according to an embodiment of the present invention;

FIG. 8 is a flowchart showing in detail a 3D model reconstruction step for stationary objects shown in FIG. 7; and

FIG. 9 is a flowchart showing in detail a motion model reconstruction step for moving objects shown in FIG. 7.

### DESCRIPTION OF THE PREFERRED EMBODIMENTS

The present invention is configured to reconstruct the scene of a traffic accident into an actual image-based 3D traffic accident scene so as to more accurately analyze the cause of the traffic accident, and to utilize and combine images of the scene of the traffic accident captured in various forms such as black box images captured in other vehicles, images recorded by CCTVs installed on a road, and images captured by mobile phones (smart phones or the like), without utilizing a single image so as to reconstruct the scene of the traffic accident. Further, the present invention is configured to acquire the length information or the like of various objects such as lane information in the area of a traffic accident or to operate in conjunction with a GIS system so as to obtain exact measurement information, thus detecting the size values of the objects in the reconstructed image and further improving measurement precision.

Hereinafter, an apparatus and method for reconstructing the scene of a traffic accident according to embodiments of the present invention will be described in detail with reference to the attached drawings. Prior to the following detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the embodiments and the configurations at the time at which the present application is filed.

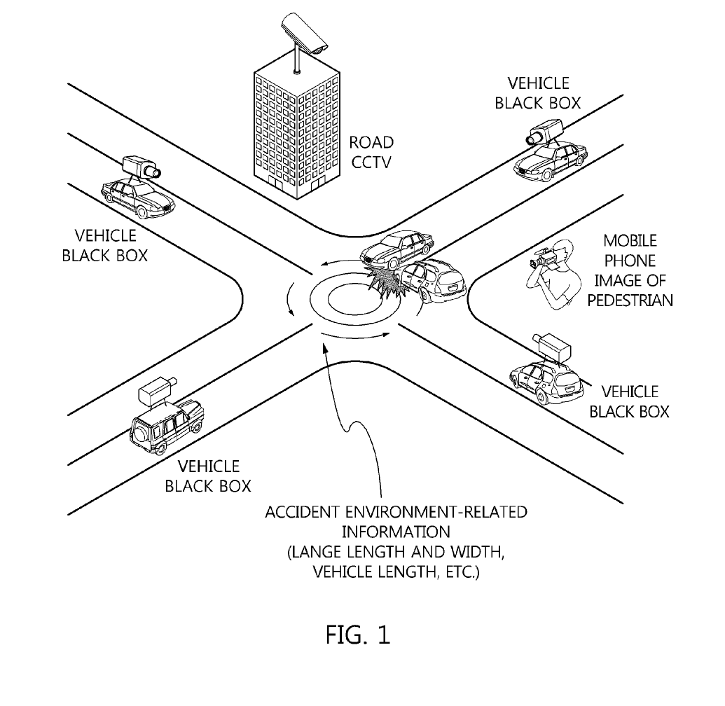

FIG. 1 is a diagram showing an example of the scene of a traffic accident employed in an embodiment of the present invention.

As illustrated in FIG. 1, when a traffic accident occurs in the middle of a road, the apparatus of the present invention is provided with images/sounds of black boxes installed in a plurality of vehicles to capture and record the scene of the traffic accident, images recorded by CCTVs installed on road infrastructures, and images/sounds captured and recorded by the mobile phone of a pedestrian around the scene of the traffic accident. Further, the apparatus of the present invention may be provided with the measurement information of objects (for example, the length of a lane on a road, the length of the license plate of a vehicle, etc.) in a road environment.

In this way, the apparatus of the present invention requires image and/or sound data acquired by capturing the scene of a traffic accident from various viewpoints, such as black box images/sounds acquired by vehicles passing by the scene of the traffic accident, images of CCTVs installed in the road infrastructures and acquired by capturing images of the scene of the accident, and images/sounds of mobile phones around the scene of the accident, in order to reconstruct and reproduce an actual image-based 3D traffic accident scene.

Meanwhile, the apparatus of the present invention may require measurement information related to feature information present in the scene of the traffic accident such as a lane or a platform edge by operating in conjunction with a high-precision GIS system or by performing direct measurement.

For the image data of the scene of the traffic accident, it is preferable to eliminate shadow areas from the image data and acquire an amount of image information that is as large as possible so as to improve the precision of 3D reconstruction.

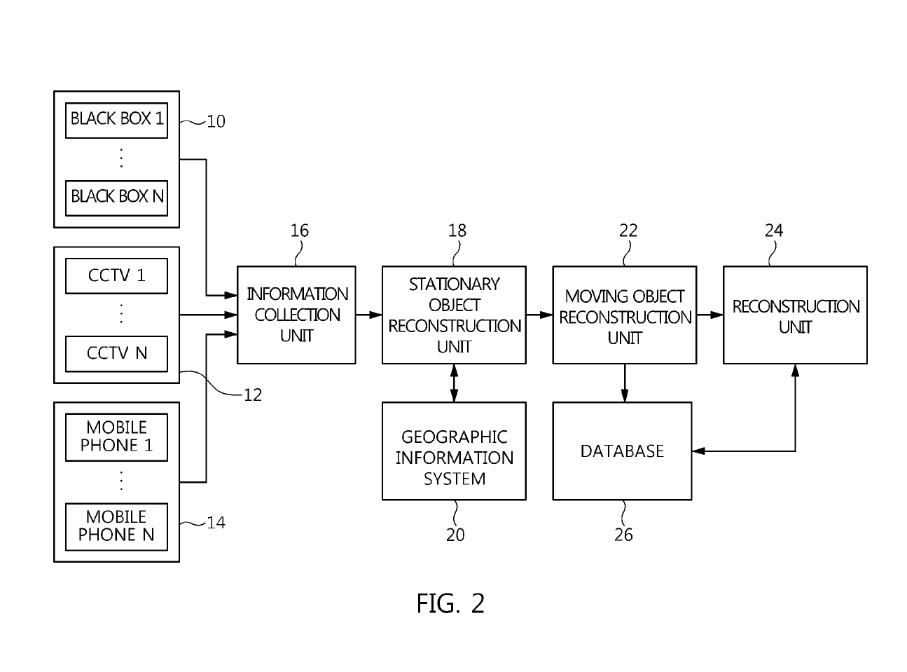

FIG. 2 is a diagram showing the configuration of an apparatus for reconstructing the scene of a traffic accident according to an embodiment of the present invention.

The apparatus shown in FIG. 2 includes information provision means 10, 12, and 14, an information collection unit 16, a stationary object reconstruction unit 18, a geographic information system 20, a moving object reconstruction unit 22, a reproduction unit 24, and a database (DB) 26.

The black boxes 10 of the information provision means are installed in respective vehicles. Each black box 10 provides information acquired by capturing and recording objects placed ahead of/behind a vehicle and external environments surrounding the vehicle (for example, image and sound information) to the information collection unit 16. That is, the black box 10 may capture and record the image information and sound information of other vehicles, persons, or other moving objects which are approaching the corresponding vehicle, and stationary objects, and may provide the image and sound information to the information collection unit 16. Meanwhile, when a traffic accident occurs, the black box 10 may transmit images/sound information acquired at predetermined times before and after the time of occurrence of the traffic accident to the information collection unit 16.

The CCTVs 12 of the information provision means are installed on a roadside to face the load. Each CCTV 12 provides information acquired by capturing and recording various types of environments including moving objects on the road (for example, a vehicle a bicycle, a motorcycle, etc.) and stationary objects around the road (for example, a tree, a building, etc.) to the information collection unit 16. For example, if a person stands on or around the road, he or she may be a stationary object, but, if the person is moving, he or she may be a moving object.

The mobile phones 14 of the information provision means are devices carried by persons and are capable of capturing images and recording sounds. When a traffic accident occurs, a pedestrian located around the road provides information, acquired by capturing and recording the situation of the scene (including moving objects and stationary objects) in which the traffic accident has occurred via his or her mobile phone 14, to the information collection unit 16.

In this way, the black boxes 10, the CCTVs 12, and the mobile phones 14 may provide image information and sound information about the scene of the traffic accident and about stationary objects and moving objects around the scene to the information collection unit 16.

The information collection unit 16 receives the image information and sound information about the scene of the traffic accident and about the stationary objects and moving objects around the scene from the black boxes 10, the CCTVs 12, and the mobile phones 14.

The stationary object reconstruction unit 18 reconstructs 3D shapes of the stationary objects based on the images received through the information collection unit 16. The stationary object reconstruction unit 18 may construct a 3D accident environment including one or more of the reconstructed 3D shapes of the stationary objects. Here, since the 3D accident environment includes one or more stationary objects, it may also be referred to as a ‘3D stationary environment.’

The geographic information system 20 provides topographic information, obtained by integrating geographic data corresponding to spatial location information with attribute data related thereto (for example, altitude, gradient, etc.), to the stationary object reconstruction unit 18. For example, when the stationary object reconstruction unit 18 requests the topographic information of the scene in which the traffic accident has occurred, the geographic information system 20 may transmit the topographic information of the scene in which the traffic accident has occurred. In this way, association with the geographic information system 20 enables the size values of the objects in the reconstructed images to be known and then further improves measurement precision.

The moving object reconstruction unit 22 reconstructs and combines the motion information of moving objects generated with respect to stationary environment information, with reference to information output from the information collection unit 16 and the stationary object reconstruction unit 18. In greater detail, the moving object reconstruction unit 22 aligns the images received through the information collection unit 16 in time, detects the motions of the moving objects from the aligned images, and combines the detected motions of the moving objects into the 3D accident environment including the reconstructed stationary objects, according to individual times.

When a time-based playback request is received from a user, the reproduction unit 24 reproduces the scene of the traffic accident at the corresponding time based on the results of the combination by the moving object reconstruction unit 22. In this case, the reproduction unit 24 reproduces the scene of the traffic accident in which actual image-based 3D moving objects are moving.

The reproduction unit 24 uses modeling information of the 3D accident scene obtained by the stationary object reconstruction unit 18 and the moving object reconstruction unit 22 so as to reconstruct the scene of the traffic accident. Since the 3D modeling information of the stationary objects is extracted by the stationary object reconstruction unit 18, and the 3D modeling information of the moving objects is extracted by the moving object reconstruction unit 22, the reproduction unit 24 is capable of representing the scene of the traffic accident by performing a 3D rendering task using a typical computer graphics technique, and enables the 3D accident scene to be viewed from various viewpoints.

In the case of stationary objects, the 3D modeling information of the positions and postures thereof is always fixed, but in the case of moving objects, the 3D modeling information of the positions and postures thereof varies with time. Therefore, if each frame is varied using time information, moving objects are moved in the same manner as that in the situation of the traffic accident based on the 3D modeling information of the moving objects in the corresponding frame. Consequently, when the user requires time-based playback, moving objects such as a vehicle and a person are moved, so that the scene of the accident is reconstructed without change, thus enabling the scene of the traffic accident to be viewed from various viewpoints.

The DB 26 stores the results of the combination by the moving object reconstruction unit 22 (that is, the results obtained by combining the motions of the moving objects into the 3D accident environment including the reconstructed stationary objects according to individual times). The information of the DB 26 is stored as accident scene reconstruction information and used as data thereof.

The information stored in the DB 26 may be read by the reproduction unit 24 at anytime and may be used to reconstruct the scene of a traffic accident. Since accident scene reconstruction information has detailed information about the situation of the traffic accident, the utilization thereof is high.

When accident scene reconstruction information is desirably stored as data in addition to the determination of the responsibility for the accident, such information may be utilized as safety information into which the surrounding situation of an accident occurrence area, the behavior of a driver, the motion state of the vehicle, etc. are integrated. Further, such accident scene reconstruction information may be utilized as base data required to improve the stability of the vehicle in a vehicle manufacturer, as well as the informatization of the condition of the vehicle caused by the accident (the degree of damage, the state of an airbag, and the state of a slip). Furthermore, such information may be utilized as precise statistical data about the types and states of the occurrence of accidents for respective roads, vehicles, and drivers.

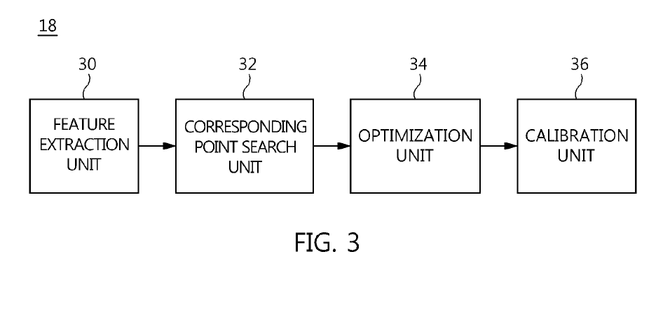

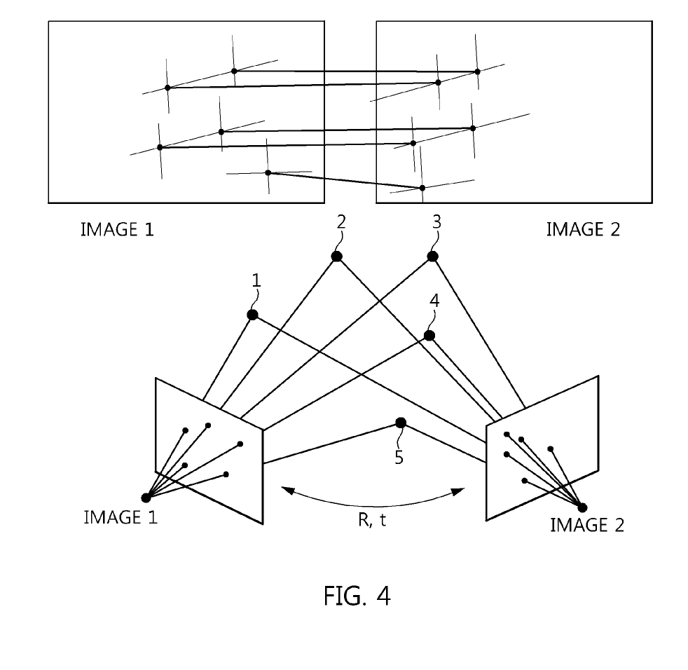

FIG. 3 is a diagram showing the internal configuration of the stationary object reconstruction unit 18 shown in FIG. 2, and FIG. 4 is a diagram showing a relationship between corresponding points and cameras according to an embodiment of the present invention.

The stationary object reconstruction unit 18 includes a feature extraction unit 30, a corresponding point search unit 32, an optimization unit 34, and a calibration unit 36.

The feature extraction unit 30 extracts features from all images collected by the information collection unit 16. Here, it may be considered that methods of extracting features from images are sufficiently understood by those skilled in the art from well-known technology.

The corresponding point search unit 32 searches all images for the corresponding points of the features extracted by the feature extraction unit 30. Upon searching for the corresponding points, the corresponding point search unit 32 primarily searches for the corresponding points between frames of each image sequence by using characteristics that the respective image sequences are temporally consecutive images, and thereafter secondarily searches for corresponding points between the image sequences. In this case, as shown in FIG. 4, corresponding points, between which inconsistency of the epipolar geometry is present, are removed by using the relationship between the corresponding points and the cameras. For this, a random sample consensus (RANSAC) method or the like may be used. Here, the term “epipolar geometry” denotes the theory that, in pieces of image information acquired by capturing a single 3D point using two cameras, two vectors from the locations of the cameras and image points facing the cameras are coplanar.

The searching for corresponding points will be described in detail. A geometric relationship between corresponding points and cameras is shown in FIG. 4, which is called epipolar geometry. Points present in a 3D space are projected and shown onto 2D planes of images of the cameras. In this way, searching for corresponding points denotes a procedure for searching for a pair of points projected onto the respective 2D planes, and this corresponding point pair satisfies the relationship such as that given in the following Equation (1):

X′^{T}FX=0 (1)

where X′ denotes the coordinates of image 1 for the respective corresponding points, X denotes the coordinates of image 2, F denotes a fundamental matrix, and T denotes a transpose of X′.

Further, the fundamental matrix F is defined by the following Equation (2):

F=K′^{-T}[t]ₓRK⁻¹ (2)

where K′ denotes the calibration matrix of image 1 (camera 1), K denotes the calibration matrix of image 2 (camera 2), and t and R denote matrixes respectively indicating the movement and rotation between images 1 and 2. Further, −T denotes the inverse transpose of K′. Furthermore, [•]ₓ denotes a skew-symmetric matrix function, and may be defined by

$${[ t ]}_{x} = [ \begin{matrix}0 & - z & y \\ z & 0 & - x \\ - y & x & 0\end{matrix} ]$$

when vector is t=[x y z]^{T}.

As described above, all corresponding points must satisfy the condition given in Equation (1). In other words, since corresponding points which do not satisfy the condition in Equation (1) are falsely found corresponding points, they must be removed. For this, a RANSAC method or the like may be used. RANSAC is a robust algorithm for determining whether pieces of randomly selected sample information satisfy a desired condition. By utilizing RANSAC, a number of samples identical to the number of samples required to obtain a fundamental matrix F are randomly selected and thus the fundamental matrix F is obtained. It is determined whether the condition of Equation (1) is satisfied, based on the obtained fundamental matrix F. Upon repeatedly performing this operation several times, the value of a fundamental matrix obtained when a largest number of corresponding points satisfy the condition of Equation (1) is the value of ‘true’. In this case, the corresponding points which do not satisfy the condition of Equation (1) are removed. In FIG. 4, it may be considered that points 1, 2, 3, and 4 are points satisfying the condition of Equation (1), and point (5) does not satisfy the condition of Equation (1).

The optimization unit 34 obtains 3D location coordinates of the corresponding points found by the corresponding point search unit 32. Since the internal parameters of the black boxes 10, the CCTVs 12, and the mobile phones 14 are not known, the optimization unit 34 obtains 3D location coordinates configured to have internal parameters and 2D coordinates of the corresponding points as variables and to optimize the respective variables, and the internal parameters of the respective cameras (that is, the black boxes 10, the CCTVs 12, and the mobile phones 14) in order to more exactly obtain the 3D location coordinates of the corresponding points. For this optimization, a method such as sparse bundle adjustment may be used. Sparse bundle adjustment is a method of finding optimal values of camera parameters and respective 3D location coordinate values which are required to minimize errors occurring when the 3D location coordinates of the corresponding points are re-projected onto the images.

The calibration unit 36 calibrates the scale of the 3D location coordinates based on really measured or estimated data. In other words, since the exact scale of the 3D location coordinates of the respective corresponding points obtained by the optimization unit 34 cannot be known, the calibration unit 36 calibrates the scale of all the 3D location coordinate values in response to actually measured values or values estimated and input by the user for the width of a lane, the size of a platform edge, the size of the vehicle, or the size of a specific object. Accordingly, it is possible to reconstruct exact 3D location coordinates of each stationary object and construct a 3D accident environment including one or more 3D stationary objects.

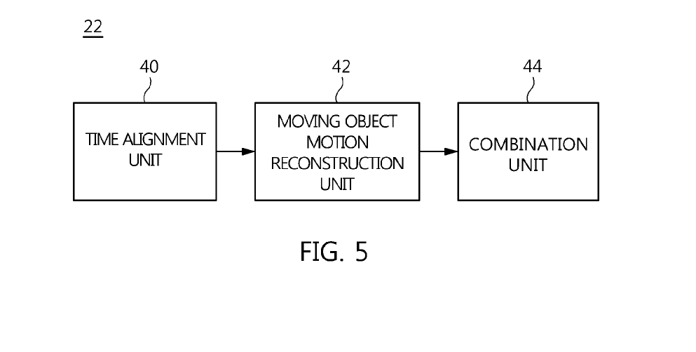

FIG. 5 is a diagram showing the internal configuration of the moving object reconstruction unit 22 shown in FIG. 2, and t is a diagram showing the time synchronization and alignment between image sequences according to an embodiment of the present invention.

The moving object reconstruction unit 22 detects motions observed from a plurality of image sequences, combines the motions with each other, and enables omnidirectional states of an accident situation with time to be viewed. For this, the moving object reconstruction unit 22 includes a time alignment unit 40, a moving object motion reconstruction unit 42, and a combination unit 44.

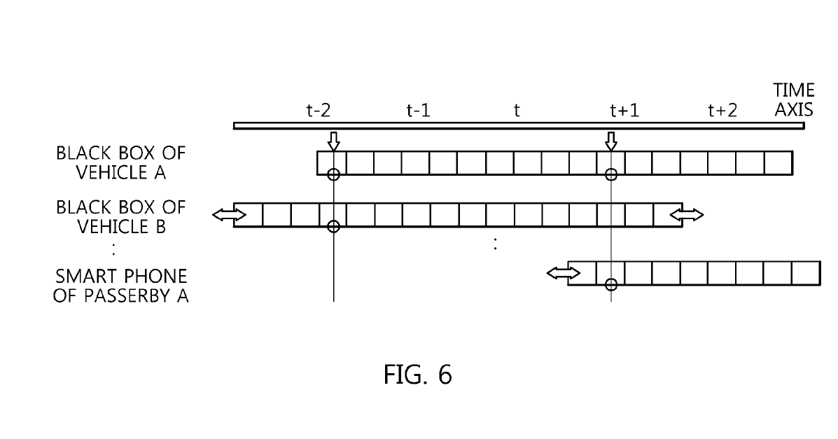

The time alignment unit 40 performs an alignment task of aligning input image sequences in time. That is, the time alignment unit 40 aligns input images in time for respective image sequences. As illustrated in FIG. 6, since the image sequences are images captured by different cameras (for example, black box of vehicle A, black box of vehicle B, and smart phone of passerby A), time synchronization information is not present. Therefore, in order to temporally synchronize the image sequences, the time alignment unit 40 may use the following several methods. A first method is configured such that, in the case of image sequences considered to be in similar direction, a time at which the number of corresponding points removed due to epipolar geometry is minimized or at which the ratio of corresponding points is minimized upon obtaining corresponding points between image sequences may be considered to be an identical time. This denotes a time at which a difference in variations between images is minimized, and occurs when time synchronization between images is realized. Therefore, the image sequences may be aligned based on the time at which a difference in variations between the images is minimized A second method is configured such that when image sequences include common sound information, they may be synchronized with each other using the common sound information. By using the common sound information, the image sequences may be aligned in time. A third method is configured such that, when common motion is observed from image sequences, the image sequences are temporally synchronized based on the common motion. By using this common motion, the image sequences may be aligned in time. Finally, there is a method in which when synchronization cannot be realized using such an acoustic or visual method, the user may synchronize the image sequences by adjusting the time code of the images while personally viewing the image sequences. Here, when images are temporally synchronized using the sound of a collision such as in an accident of a vehicle based on sounds, a time alignment task must be performed in consideration of even distances from image-capturing cameras to the scene of the traffic accident with reference to the transmission time of sounds.

As illustrated in FIG. 6, if it is assumed that a time at which a difference in variations between images is minimized, a time at which common sound information is present, a time at which common motion is present, or adjusted time code corresponds to t−2 and t+1, the image sequences of the respective cameras (in FIG. 6, the black box of vehicle A, the black box of vehicle B, the smart phone of passerby A, etc.) are temporally synchronized and aligned in time because they are shifted to the left or to the right by the time alignment unit 40. That is, in FIG. 6, the image of the black box of vehicle A is synchronized with the image of the smart phone of passerby A at time t+1 and is synchronized with the image of the black box of vehicle B at time t−2.

The moving object motion reconstruction unit 42 obtains the locations of motions of moving objects present in respective image sequences which are temporally synchronized with each other. That is, the moving object motion reconstruction unit 42 may obtain corresponding points between the image sequences which are temporally synchronized by the time alignment unit 40, and obtain the absolute locations of the objects at that time. In this case, the shapes of the stationary objects obtained by the stationary object reconstruction unit 18 are removed, and thus it is possible to obtain the locations of only the moving objects (in greater detail, the locations of the motions of the moving objects).

The combination unit 44 combines the motions of the moving objects into the 3D accident environment so that they are temporally synchronized with each other. Since the motions of the moving objects in respective image sequences obtained by the moving object motion reconstruction unit 42 are separately present, the utility value thereof is deteriorated. Therefore, the combination unit 44 temporally synchronizes and combines the motions of moving objects in respective image sequences into the 3D stationary environment, obtained by the stationary object reconstruction unit 18, according to individual times, thus obtaining the final combination results.

In the above description, although the stationary object reconstruction unit 18 has been described as constructing the 3D accident environment, it is also possible for the combination unit 44 to construct a 3D accident environment.

When the combination unit 44 may construct a 3D accident environment, it constructs an actual image-based 3D stationary environment for the scene of the traffic accident based on epipolar geometry information between the 3D location coordinates of the corresponding points for the stationary environment obtained by the stationary object reconstruction unit 18 and the cameras. Further, the combination unit 44 combines the motions of the moving objects obtained by the moving object motion reconstruction unit 42 into the actual image-based 3D stationary environment so that the motions are temporally synchronized with each other. In this case, in order to obtain optimal results, it is preferable to optimize the results of the motions of the respective moving objects.

In this way, the stationary 3D accident environment and information about the motions of the respective objects with time may be finally obtained, and thus exact 3D accident information with time may be reconstructed.

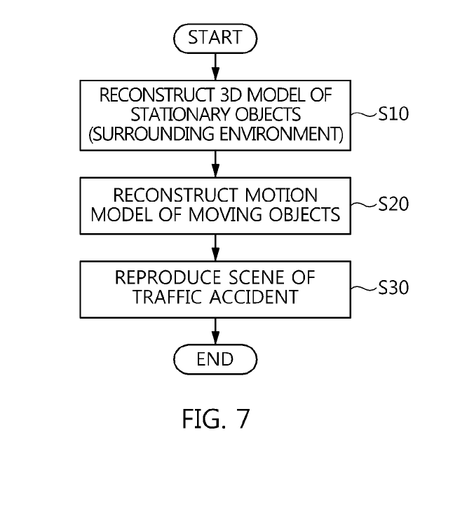

FIG. 7 is a flowchart schematically showing a method for reconstructing the scene of a traffic accident according to an embodiment of the present invention.

The method of reconstructing the scene of a traffic accident according to the embodiment of the present invention is configured to reconstruct the scene of a traffic accident in 3D by using image information and sound information received from the black boxes 10, CCTVs 12, and mobile phones 14.

In this way, the method of reconstructing and reproducing the scene of a traffic accident in 3D may be regarded as being composed of three steps, as shown in FIG. 7.

First, at step S10, the stationary object reconstruction unit 18 reconstructs 3D object information about a stationary object area which is not moved and is a background, such as buildings or roads, for each of the image sequences of the black boxes 10, the CCTVs 12, and the mobile phones 14 collected by the information collection unit 16.

Then, at step S20, the moving object reconstruction unit 22 reconstructs and combines the motion information of moving objects generated in accordance with the stationary environment information by referring to the generated 3D object information.

Finally, at step S30, the reproduction unit 24 reproduces the scene of a traffic accident by performing a 3D rendering task. For example, when the user requests time-based playback, the reproduction unit 24 causes moving objects such as vehicles or persons to be moved, and stationary objects such as trees, precast pavers, or buildings to be fixed, thus enabling the scene of the traffic accident to be reproduced without change.

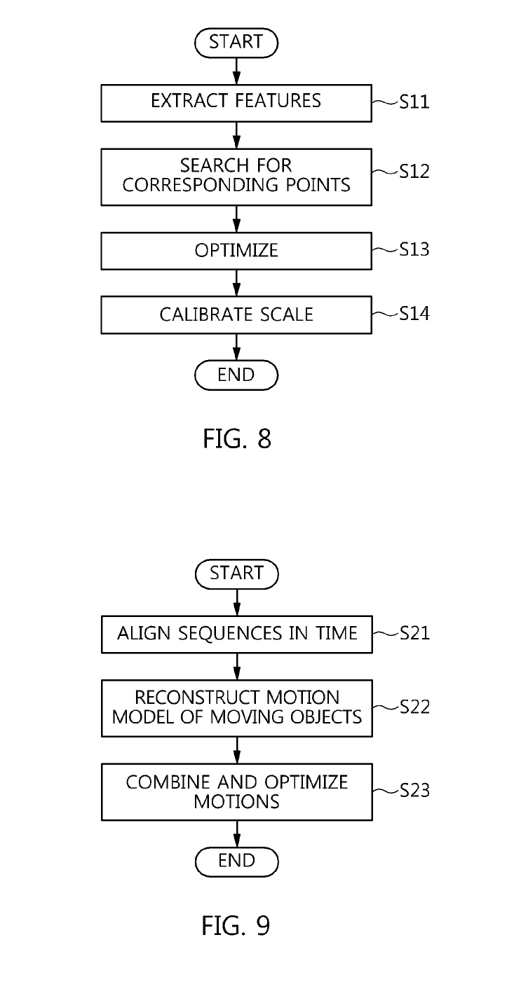

FIG. 8 is a flowchart showing in detail the 3D model reconstruction step for stationary objects shown in FIG. 7.

First, at step S11, the feature extraction unit 30 of the stationary object reconstruction unit 18 extracts features from all images.

At step S12, the corresponding point search unit 32 of the stationary object reconstruction unit 18 searches all of the images for the corresponding points of the features extracted by the feature extraction unit 30.

Then, at step S13, the optimization unit 34 of the stationary object reconstruction unit 18 obtains the 3D location coordinates of the corresponding points found by the corresponding point search unit 32.

Finally, at step S14, the calibration unit 36 of the stationary object reconstruction unit 18 calibrates the scale of all of the 3D location coordinate values in response to actually measured values or values estimated and input by the user, for the width of a lane, the size of a platform edge, the size of the corresponding vehicle, or the size of a specific object.

FIG. 9 is a flowchart showing in detail the motion model reconstruction step for moving objects shown in FIG. 7.

First, at step S21, the time alignment unit 40 of the moving object reconstruction unit 22 aligns input image sequences in time so as to reconstruct the motions of all moving objects in 3D.

At step S22, the moving object motion reconstruction unit 42 of the moving object reconstruction unit 22 obtains corresponding points between the image sequences temporally synchronized and aligned by the time alignment unit 40, and obtains the absolute locations of the objects at that time. In this case, the moving object motion reconstruction unit 42 removes the shapes of the stationary objects obtained by the stationary object reconstruction unit 18, thus obtaining the locations of only the moving objects.

Finally, at step S23, the combination unit 44 of the moving object reconstruction unit 22 combines the motions of the moving objects obtained by the moving object motion reconstruction unit 42 into a 3D stationary environment so that the motions become motions at respective times synchronized with the 3D stationary environment, thus obtaining the final combination results.

In accordance with the present invention having the above configuration, it combines images from various sources, which capture scenes before and after a traffic accident via various black boxes, CCTVs, or mobile phones, thus reconstructing an actual image-based 3D traffic accident scene.

The present invention is advantageous in that scenes ranging from a situation immediately before the occurrence of a traffic accident to a situation in which the traffic accident has occurred may be very realistically reconstructed in 3D, so that, when the complex cause of the traffic accident is present, the cause of the traffic accident may be accurately analyzed based on fact.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for reconstructing a scene of a traffic accident, comprising:
an information collection unit for receiving images and sounds of a scene of a traffic accident and a stationary object and a moving object located around the scene;
a stationary object reconstruction unit for reconstructing a three-dimensional (3D) shape of the stationary object based on the received images, and constructing a 3D accident environment;
a moving object reconstruction unit for aligning the received images in time, detecting motions of the moving object from the aligned images, and combining the detected motions of the moving object into the 3D accident environment including the reconstructed stationary object according to individual times; and
a reproduction unit for reproducing the scene of the traffic accident at a corresponding time based on results of combination by the moving object reconstruction unit in response to a time-based playback request, the scene of the traffic accident being reproduced so that the 3D moving object is moved.

2. The apparatus of claim 1, wherein the information collection unit receives images and sounds from a black box installed in a vehicle, a Closed Circuit Television (CCTV) installed on a roadside, and a mobile phone.

3. The apparatus of claim 1, wherein the stationary object reconstruction unit comprises:
a feature extraction unit for extracting features from the images collected by the information collection unit;
a corresponding point search unit for searching for corresponding points of the extracted features;
an optimization unit for obtaining 3D location coordinates of found corresponding points; and
a calibration unit for calibrating a scale of the 3D location coordinates based on actually measured data or estimated data.

4. The apparatus of claim 1, wherein the moving object reconstruction unit comprises:
a time alignment unit for aligning the received images in time for respective sequences;
a moving object motion reconstruction unit for obtaining locations of motions of the moving object present in the respective image sequences that are temporally synchronized; and
a combination unit for combining the motions of the moving object into the 3D accident environment so that the motions are temporally synchronized with each other.

5. The apparatus of claim 4, wherein the time alignment unit aligns the received images by using a time, at which a difference in variations between the received images is minimized, as an identical time at which the images are temporally synchronized with each other.

6. The apparatus of claim 4, wherein the time alignment unit aligns the received images based on a common sound when sounds are included in the received images.

7. The apparatus of claim 4, wherein the time alignment unit receives a signal obtained by adjusting time code of the received images, and aligns the received images based on the signal.

8. The apparatus of claim 1, wherein the reproduction unit reproduces the scene of the traffic accident by performing a 3D rendering task.

9. The apparatus of claim 1, further comprising a database for storing results of combination by the moving object reconstruction unit.

10. A method for reconstructing a scene of a traffic accident, comprising:
receiving, by an information collection unit, images and sounds of a scene of a traffic accident and a stationary object and a moving object located around the scene;
reconstructing, by a stationary object reconstruction unit, a three-dimensional (3D) shape of the stationary object based on the received images, and constructing a 3D accident environment;
aligning, by a moving object reconstruction unit, the received images in time, detecting motions of the moving object from the aligned images, and combining the detected motions of the moving object into the 3D accident environment including the reconstructed stationary object according to individual times; and
reproducing, by a reproduction unit, the scene of the traffic accident at a corresponding time based on results of the combination in response to a time-based playback request, the scene of the traffic accident being reproduced so that the 3D moving object is moved.

11. The method of claim 10, wherein receiving is configured to receive images and sounds from a black box installed in a vehicle, a Closed Circuit Television (CCTV) installed on a roadside, and a mobile phone.

12. The method of claim 10, wherein constructing the 3D accident environment comprises:
extracting features from the images received at receiving;
searching for corresponding points of the extracted features;
obtaining 3D location coordinates of found corresponding points; and
calibrating a scale of the 3D location coordinates based on actually measured data or estimated data.

13. The method of claim 10, wherein combining comprises:
aligning the received images in time for respective sequences;
obtaining locations of motions of the moving object present in the respective image sequences that are temporally synchronized; and
combining the motions of the moving object into the 3D accident environment so that the motions are temporally synchronized with each other.

14. The method of claim 13, wherein aligning is configured to align the received images by using a time, at which a difference in variations between the received images is minimized, as an identical time at which the images are temporally synchronized with each other.

15. The method of claim 13, wherein aligning is configured to align the received images based on a common sound when sounds are included in the received images.

16. The method of claim 13, wherein aligning is configured to receive a signal obtained by adjusting time code of the received images, and align the received images based on the signal.

17. The method of claim 10, wherein reproducing is configured to reproduce the scene of the traffic accident by performing a 3D rendering task.
